(19) United States
(12) Patent Application Publication
(10) Pub. No.: US 2018/0290748 A1
(43) Pub. Date: Oct. 11, 2018

(54) AUTONOMOUS IN-TUNNEL INTELLIGENCE, SURVEILLANCE, AND RECONNAISSANCE DRONE

(71) Applicant: Versatol, LLC, McDonough, GA (US)

(72) Inventors: Lawrence C. Corban, McDonough, GA (US); John Eric Corban, McDonough, GA (US); Eric Graham Leal, College Park, GA (US)

(73) Assignee: Versatol, LLC, McDonough, GA (US)

(21) Appl. No.: 15/944,220

(22) Filed: Apr. 3, 2018

Related U.S. Application Data
(60) Provisional application No. 62/480,651, filed on Apr. 3, 2017.

(51) Int. Cl. B64C 39/02; G05D 1/00; G05D 1/10; G06T 19/00; G02B 27/01; G06F 3/01; H04W 4/40

(52) U.S. Cl. CPC B64C 39/024; G05D 1/0016; G05D 1/0088; G05D 1/0038; G05D 1/101; B64C 2201/148; G02B 27/017; G06F 3/012; H04W 4/40; B64C 2201/123; B64C 2201/141; G06T 19/006

(57) ABSTRACT

A small unmanned aircraft system is outfitted with a variety of sensors, and communications equipment to enable autonomous, remote exploration and mapping of spaces non line of sight (NLOS), and in the absence of global positioning signals.

### BACKGROUND OF THE INVENTIONS

### 1. Technical Field

The present inventions relate to remote sensing, and, more particularly, relate to sub-systems, and methods for remotely imaging and mapping the interior of a dark tunnel or cavity, especially in the absence of Global Positioning System signals.

### 2. Description of the Related Art

A wealth of commercial methods, systems, and sub-systems are documented, and routinely operated globally for remotely imaging the interior of mines, municipal infrastructure, and buildings. These systems typically employ wheels as a means of locomotion and are therefore slow with very limited vertical mobility.

### BRIEF DESCRIPTION OF THE DRAWINGS

The present inventions are illustrated by way of example and are not limited by the accompanying figures, in which like references indicate similar elements. Elements in the figures are illustrated for simplicity and clarity and have not necessarily been drawn to scale.

The details of the preferred embodiments will be more readily understood from the following detailed description when read in conjunction with the accompanying drawings wherein:

FIG. 1 illustrates an orthogonal view of a small unmanned aircraft system (sUAS) tightly integrated with a plurality of sensors needed to enable advanced autonomy, and a fully immersive, virtual reality (VR) operator interface;

FIG. 2 illustrates a ground station and fully immersive VR operator interface connected to the sUAS through the communication tether;

FIG. 3 illustrates a rear view of the sUAS inside a tunnel;

FIG. 4 illustrates a side view of the sUAS's 360 degree camera field of view inside a tunnel;

FIG. 5 illustrates an orthogonal view of the sUAS with numerous detachable radio network nodes;

FIG. 6 illustrates an orthogonal view of the radio node release mechanism, and a deployed node;

FIG. 7 Illustrates a side view of an sUAS deploying a radio node in a tunnel; and

FIG. 8 illustrates a side view of multiple drones being launched from a central ground control station.

### DETAILED DESCRIPTION OF THE PREFERRED EMBODIMENTS

A small unmanned aircraft system with adequate autonomy, and a fully-immersive virtual reality (VR) operator interface is needed to allow for greater speed, vertical mobility, and robustness to obstacles when exploring dark, confined spaces remotely. This requires the novel integration of an advanced autopilot, numerous advanced sensors, an advanced tethered communication suite, a light-weight communications tether, a small vertical take-off and landing (VTOL) UAS, remote auxiliary computing units, LED arrays for illumination, and a fully immersive, virtual reality (VR) command and control interface.

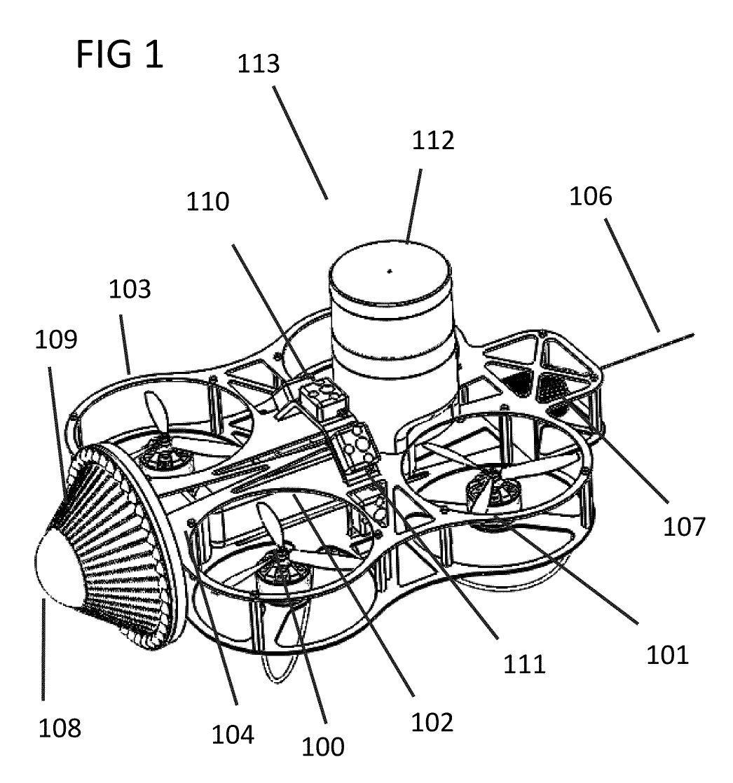

FIG. 1 illustrates a sUAS 113 comprising one or more rotors 100. The rotors are operably coupled to one or more electric motors 101. One or more onboard batteries 102 provide power to one or more of the motors 101 for locomotion. The battery 102 also acts as a counterbalance. One or more shrouds 103 protect the rotors from destruction upon collision with external surfaces. An avionics suite 104 comprising an autopilot and auxiliary computer processors sends control signals to the motors to position the sUAS 113 in 3D space. The sUAS 113 further comprises a communication suite 105 to receive and transmit information to the systems ground station 200. The communication suite 105 can transmit and receive data to and from the ground station through a tether 106 or wirelessly. The communication employs an ethernet to fiber optic media convertor. The Ethernet to fiberoptic convertor can be capable of streaming data at rates greater than 10 Gbps. The tether 106 is stored on a spool 107. A length of tether 106 is wound around the tether spool 107. As the sUAS 113 moves through 3D space, tether 106 is unwound from the spool 107 to maintain communications with the ground control station 200 as it moves further away and beyond visual line of sight of the ground station. One or more 4k, omnidirectional, 360 degree cameras 108 are attached to the sUAS 113. The 360 degree cameras 108 capture full motion video up to 360×360 degrees around the sUAS. The high resolution 360 degree video is transmitted to the communications suite 105, and then transmitted in near real-time through the tether 106 to the ground station 200. The 360 video can be recorded on-board the aircraft, on-board the ground station or both. The live video stream is received by the ground station and displayed on a virtual reality, or augmented reality headset connected to the ground station. As the operator moves his head, the display adjusts the visible field of view such that the operator see's where he's looking relative to the sUAS. This creates a highly intuitive and fully immersive virtual reality operator command and control interface that enables the operator to manually maneuver the sUAS through the tunnel or cavity with enhanced dexterity using joystick inputs. The 360 degree video is stored on a solid state data storage device. The solid state data storage device can be located on-board the sUAS or integrated with the ground station. As a result, the 360 degree video can be forensically analyzed throughout entire length of the tunnel, and with certainty that 100% of the area within visible range of the sUAS was captured. The 360 degree video can be analyzed manually or with artificial intelligence, and image processing to identify objects or areas of interest within the tunnel. The sUAS employs a plurality of light-emitting diodes (LED) embodied as an array 109 to illuminate the interior of the tunnel, confined space, or interior space so that it can be visually inspected, and maneuvered through manually by an operator using the intuitive virtual reality operator interface.

A circular bracket 111 mounts one or more low resolution ranging sensors 110 to create an array with a low-resolution 360 degree field of view. The circular arrays 360 degree view is perpendicular to the aircrafts center plane. The range data collected by the sensors 110 is transmitted to a mission computer. The mission computer can be located either on-board the sUAS, or ground station 200. If the mission computer is located on the ground station 200, the arrays range data is transmitted in near-real time to the ground station 200 via the communications suite 105, and tether 106. Once at the mission computer integrated with the ground station 200, the range data is processed and analyzed to determine the sUAS's location relative to the walls of the tunnel. Guidance commands are generated by the mission computer and transmitted to the autopilot 104 to autonomously maneuver the sUAS such that it is remains positioned in the center of the walls of the tunnel or confined space that surrounds it. This allows the sUAS to be flown manually by an operator with minimum training, and without risk of colliding with the walls of the tunnel or cavity further enhancing the operator interfaces ease of use and intuitiveness.

The sUAS employs one or more miniaturized light detection and ranging (LiDAR) sensors to create a point cloud and map the sUAS's surrounding environment. The point cloud data collected by the Lidar 112 is transmitted to the mission computer. The mission computer can be located either on-board the sUAS, or ground station. If the mission computer is located on the ground station, the point cloud data is transmitted in near-real time to the ground station 200 via the communications suite 105, and tether 106. Once at the auxiliary computer integrated with the ground station 200, the point cloud data is processed and analyzed using Simultaneous Localization and Mapping (SLAM) to determine the sUAS's location relative to sUAS's environment. Guidance commands are generated by the mission computer and transmitted to the autopilot 104 through the tether 106 so that the sUAS can autonomously explore the tunnel or confined space that surrounds it. Alternately all of these functions can be performed onboard the sUAS. In either case, this mapping and navigation function allows the sUAS to explore the tunnel autonomously and create a 3D, geo-referenced map of the tunnel further enhancing the sUAS's ease of use and utility. SLAM based on image processing can be used as an alternative to SLAM that depends on LiDAR data in order to reduce the size, complexity and cost of the integrated sensor suite onboard the sUAS. The tether spool 107 integrated with sUAS 113. The tether spool 107 is wound with tether 106. A length of tether 106 is wound around the tether spool 107. As the sUAS 113 moves through 3D space, tether 106 is unwound from the spool 107 to maintain communications with the ground control station 200 as it moves further away and beyond visual line of sight of the ground station. The tether spool 106 can be motorized or fixed. The tether spool 106 can comprise load cells to measure and manage the tension the sUAS puts on the tether. The tether spool 106 can further comprise a slip ring. The tether spool 106 can further comprise a fiberoptic slip ring. The tether spool 106 can be embodied as a line replace unit (LRU) for quick redeployment of the vehicle after it's spool has been unwound and the sUAS recovered to the operator. The tether spool 106 can be made operably detachable so that if the tether is hung on an obstacle or debris, the tether spool 106 can be mechanically detached therefore freeing the vehicle and allowing it to be recovered.

The tether 106 can be comprised of one or more conductors, one or more ground wires, fiber optic filaments, strength members, and long wire antennas. Data can be transmitted through the conductors or fiber optic filament. The tether can be embodied to function as a long wire antennae. In the case that the tether is damaged, severed, or detached from the sUAS, the tether can function as a long wire antennae, transmitting and receiving command, control, and live video streams to the GCS 200. In this manner, the sUAS can be recovered by the operator even in the case that the tether is detached or severed, and the vehicle has travelled beyond visual line of sight of the GCS radio antennae. The tether can also include a hollow tube for transferring high pressure liquids, such as water, from the GCS to the sUAS. The hollow tube is pressurized by a pump located at the GCS, transmitting liquid from the GCS to the sUAS and through a nozzle. The nozzle can be fixed or actuated to spray water and suppress dust.

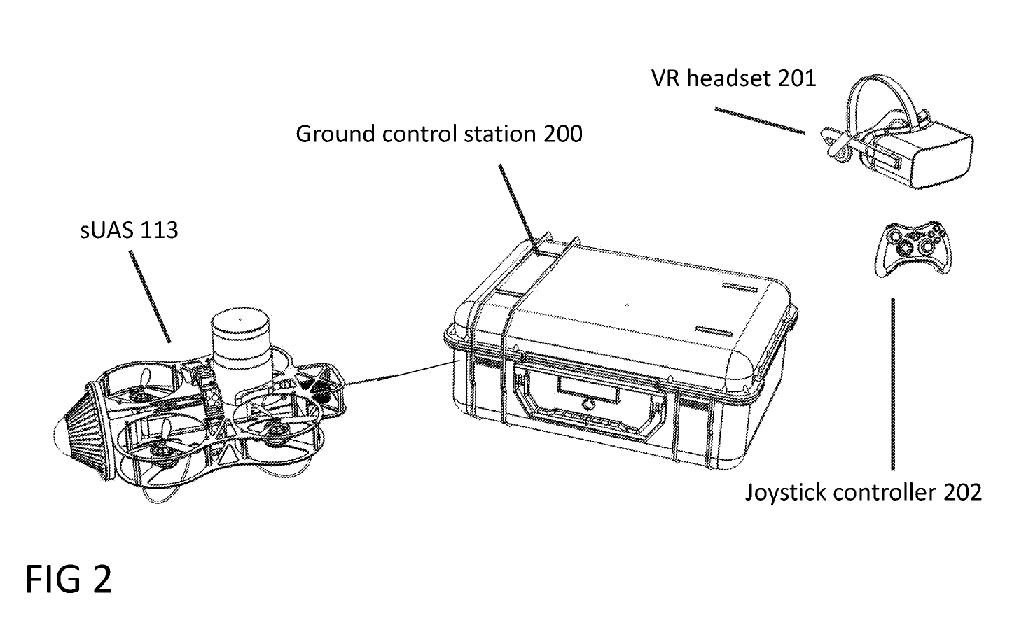

FIG. 2—FIG. 2 illustrates a ground control station (GCS) 200 and fully immersive VR operator interface. The ground control station is combined with a virtual reality (VR) headset 201, and joystick controller 202 to create the fully immersive, and intuitive virtual reality sUAS operator interface. The ground station 200 can communicate with the sUAS 113 through the tether 106 or via wireless radio communications. The GCS 200 can comprise GPS equipment and antenna, radio receivers and transmitters, fiber optic to Ethernet convertors, a high voltage up-convertor, and a modular, mission computer. The mission computer receives and fuses data from the sUAS's integrated sensor suite, archives it, and processes it according to various functions required for maximizing the systems operator interface intuitiveness and autonomy. For example, 360 video is captured by the 360 camera 108, transmitted to the ground station 200 through the tether 106, and ported to the GCS's integrated mission computer. The auxiliary computer processes the imagery so that it is viewable in virtual reality via the virtual reality (VR) headset. As the VR headset tracks the movement of the operators head movements, the auxiliary computer adjusts the VR headsets display field of view so that the operator is looking where his head is pointing in relation to the sUAS. In addition, the auxiliary computer can receive point cloud data from the sUAS's onboard LiDAR. The auxiliary computer then processes the point cloud data, performs SLAM on it, and then generates guidance commands that are subsequently transmitted back to the sUAS through the tether 106 to create a fully autonomous guidance, navigation, and collision avoidance solution. Alternately the SLAM solution can depend from image processing in combination with, or in the absence of, LiDAR data.

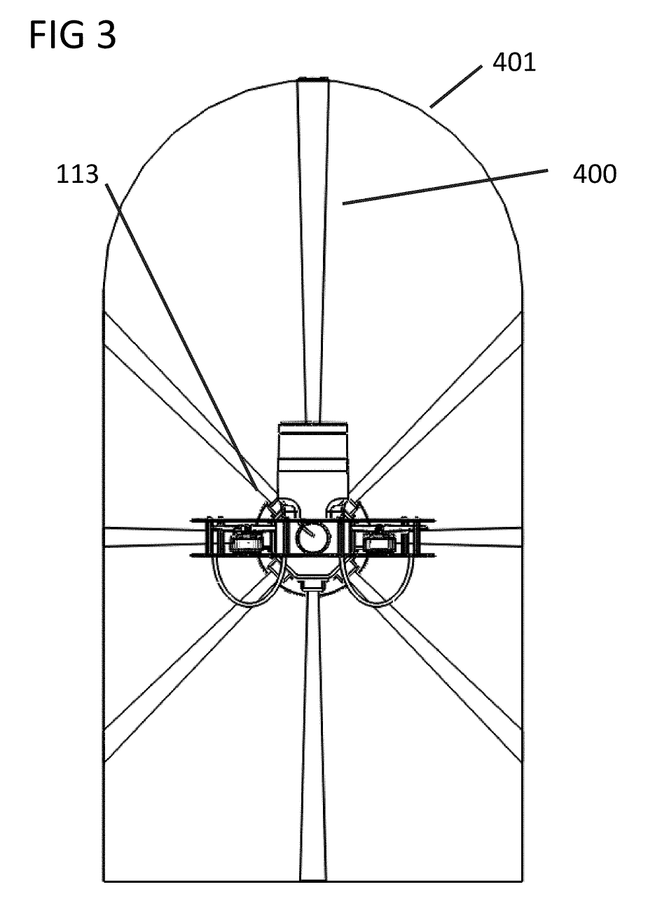

FIG. 3 illustrates the sUAS in a tunnel 401. 8 beams 400 are illustrated to represent each range sensors 110, which are mounted on the circular array 111, low resolution, narrow degree field of view. This circular array 111 of low-cost ranging sensors 110 is employed to enable the sUAS to autonomously center itself within a tunnel to make it easier for an operator to maneuver the sUAS through the tunnel without colliding with walls or obstacles. The low-resolution ranging sensors 110 can be comprised of infrared, laser, or any other time-of-flight distance sensor, such as radar, sonar, and LiDAR.

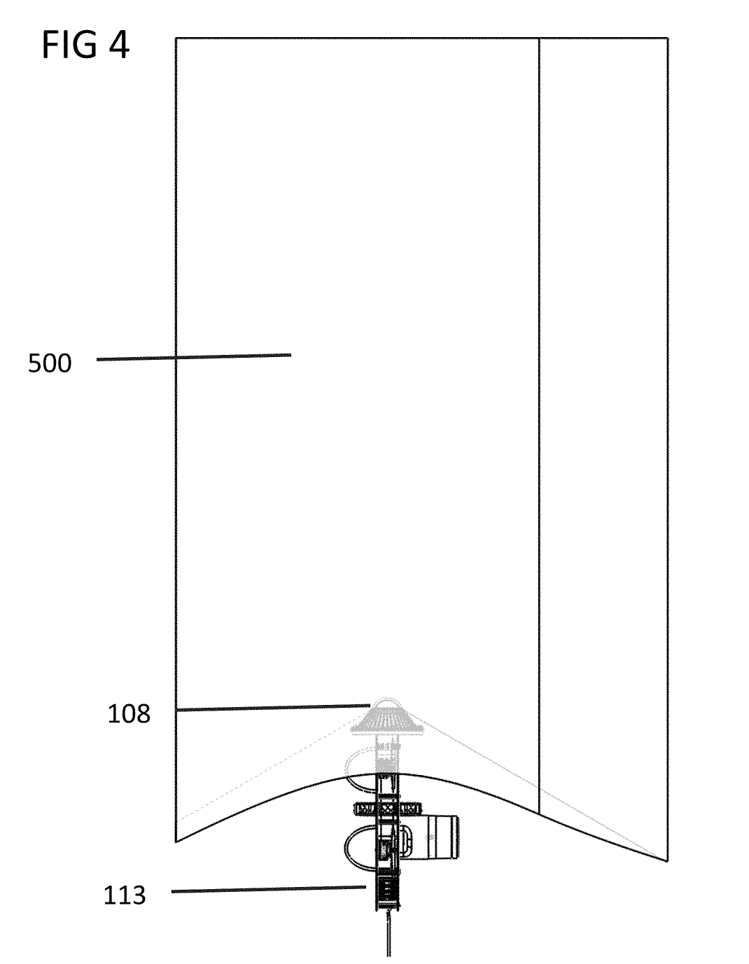

FIG. 4 illustrates the field of view 500 of the sUAS 113 outfitted with a single, forward looking 360 camera 108. The 360 degree camera's 108 field of view can be up to 360×360 degrees. The sUAS's 113 employment of one or more 360 degree cameras 108 ensures 100% imaging of the tunnel, as well as provides a live 360 degree video stream that can be viewed through a VR headset, without employment of a camera gimbal, to create a fully immersive VR operator interface.

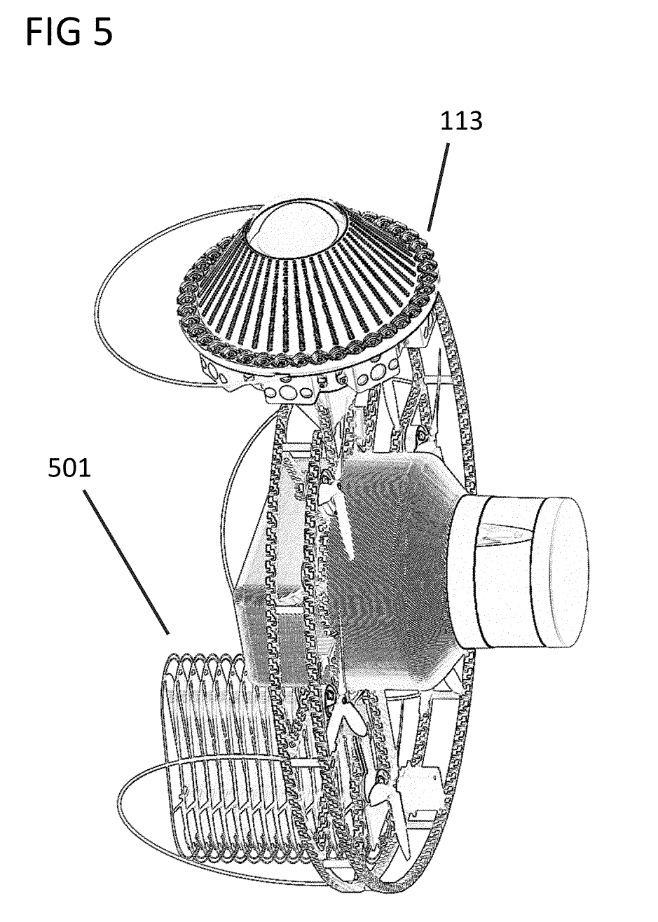

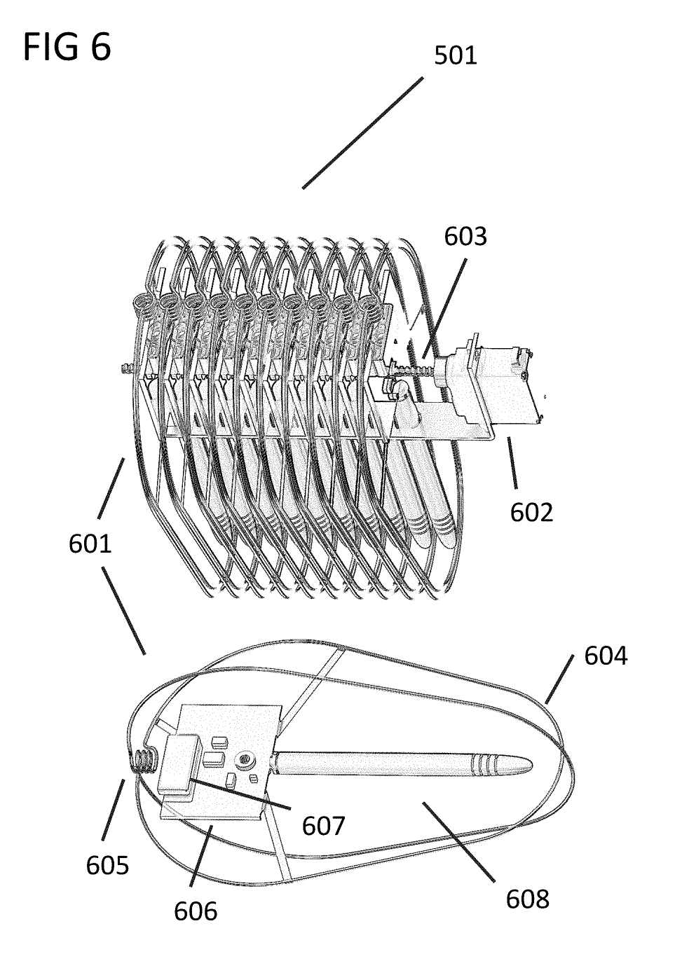

FIG. 5—FIG. 6 illustrates an orthogonal view of the sUAS outfitted 100 outfitted with a non line of sight communications suite 501.

FIG. 6—illustrates an orthogonal view of the non-line-of-sight (NLOS) communications suite 501. The NLOS communications suite comprises one or more detachable radio network nodes 601. The nodes are robotically detachable using a simple servo 602, and screw 603 mechanism. The nodes are conformable coated to be dust and water resistant and surrounded by a cage 604. The cage can comprise a spring 605 to cause it to automatically unfold upon detachment from the sUAS. The cage 604 can be designed to gravitationally self-right once unfolded and on the ground. The network node 601 comprises an electronics board 606, battery 607, and antennae 608.

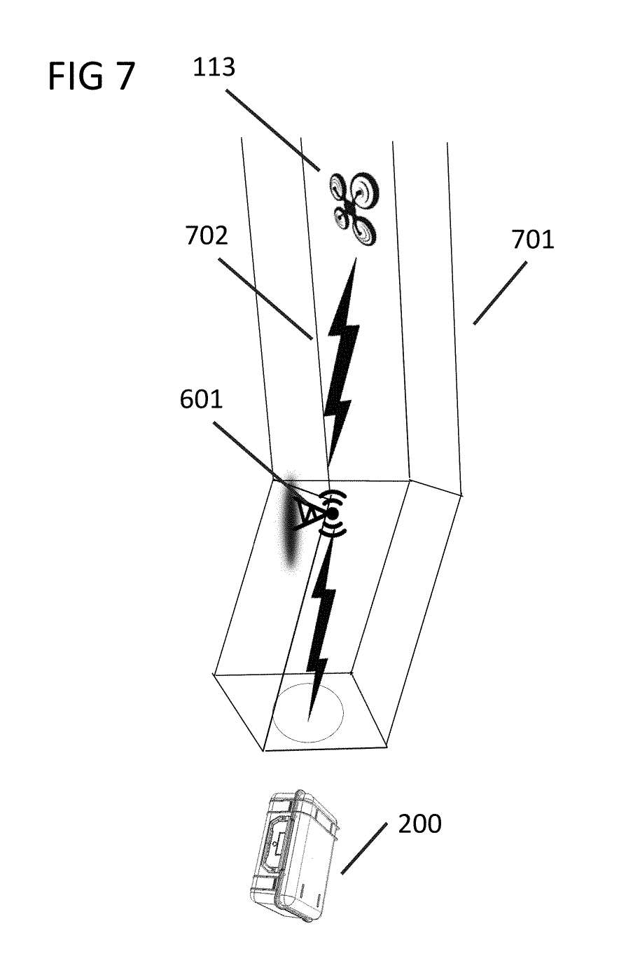

FIG. 7—illustrates a side view of an sUAS 113 autonomously navigating through an interior space 701, building a 3D map, and maintaining high bandwidth communications with the GCS 200 non-line of sight (NLOS) by relaying data 702 through one or more self-deployed network nodes 601.

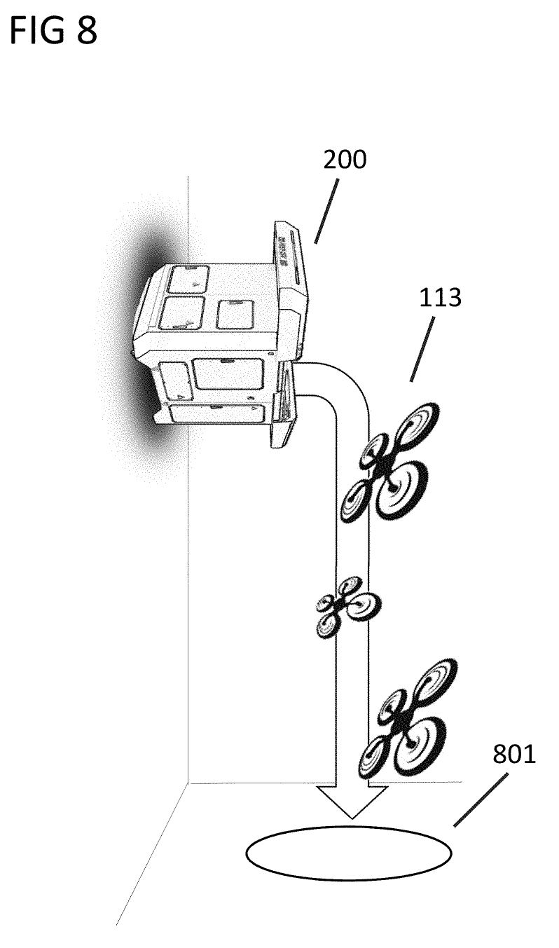

FIG. 8—illustrates one or more sUAS 113 of different type and size autonomously launching from a GCS 200 embodied as a box to collaboratively map an interior space 801.

### Further Embodiments

A next-generation in-tunnel mobile mapping drone designed to significantly improve the tactical utility of remotely imaging, and mapping confined spaces. This is achieved through the novel integration of several key, next-generation technologies. A small unmanned aircraft system (sUAS) is integrated with low-cost ranging sensors to enable reliable indoor operation without risk of collision with walls or obstacles. A high-bandwidth ethernet over fiber data communications tether is employed to maintain command and control of the vehicle beyond visual line of sight (BVLOS) and stream numerous, high resolution data sets to the ground station in near real time. A super-bright LED array illuminates the confined space for imaging. A 4K, 360 video camera is employed to ensure 100% of the area within visual range of the drone has been recorded for forensic analysis. Live 360 video is streamed through the tether and displayed to the operator in virtual reality. A miniaturized LiDAR collects over 300,000 measurements every second, streaming them directly to the ground stations mission computer for processing. COTS mobile mapping software, hosted on the mission computer, uses proven SLAM algorithms to rapidly construct a 3D map of the tunnel without GPS or any other knowledge of the vehicles position in space. The mission computer can also host next-generation artificial intelligence algorithms to autonomously identify anomalies within the data, and/or take over command and control of the aircraft entirely. All of the resulting pictures, videos, maps, and reports are archived on the ground stations high capacity data storage device and made readily accessible through the ANT app on any mobile device with a wifi connection to the ground station. Lastly, a 4G LTE hotspot, also integrated with the ground station, allows for quick and easy sharing via the cloud, while also enabling seamless, “over the air” upgrades of autonomy.

The system carries up to 1000 feet of tether, and can image a 3,000 sqft, two story building in less than 5 minutes. Once inserted, the system can be operated in two different modes; user controlled, and fully autonomous. In user controlled mode, simple collision avoidance technologies prevent the aircraft from crashing into walls or obstacles, while also centering the aircraft within the corridor and providing precision hover in the absence of GPS. Live 360 video is streamed through the tether and displayed to the operator in virtual reality, providing him a fully-immersive, first person “cockpit” view (FPV) with which to navigate. This unique combination of autonomous collision avoidance and virtual reality minimizes the operator skill required to fly in user controlled mode, and allows for manual exploration of a complex network of corridors with great dexterity and no special training.

The utility of the ANT mobile mapping system lies primarily in its ability to collect a very large, high resolution data set in a very short period of time. In only five minutes, the LiDAR will collect over ninety million measurements, and the 360 camera will capture over 5 GB of 4K video. In order for this data to yield any tactical advantage, the system must be designed to efficiently store, manage, and allow for on-demand user interaction with very large data sets. Significant tactical value is also lost if the intelligence derived from those data sets cannot be easily and intuitively distributed up the chain of command. The additional equipment required to store, process, and disseminate data sets this size are heavy, and consume significant power. Because the mobile mapping drone is primarily intended for indoor use within relatively close range of the ground station, a high-bandwidth tethered data link greatly enhances the utility of the system not only by allowing for command and control BVLOS, but also by providing the only practical means of hosting the data storage, and computing elements required for big-data management off-board the aircraft. Integrating this equipment with the aircraft, in addition to the sensors, would require a multi-rotor much larger than the 20″ diameter threshold requirement.

The ground station is comprised of 6 primary components. They are 1) a fiber to Ethernet media converter, 2) a solid-state data storage device. 3) a mission computer, 4) A wireless router, 5) A 4G LTE hot spot, and 6) a fully-immersive virtual reality interface. The fiber to Ethernet convertor receives LiDAR data, 360 video, and other various telemetry from the aircraft, through the tether, at a rate of up to 1 Gbps. All of the data is archived on the ground stations integrated solid state data storage device for processing and forensic analysis. The mission computer has ready access to this data and can use it to perform numerous functions. For example, the mission computer can receive 360 video, and display it in near real time through a head tracking VR headset to create a fully immersive virtual reality cockpit. This gives the pilot a first person view (FPV) from the aircraft and enables semi-autonomous piloting of the aircraft through complex networks of tunnels with great dexterity and ease. At the same time, the mission computer can process LiDAR and visual data using simultaneous localization and mapping (SLAM) to build geo-referenced 3D maps, and ultimately host advanced artificial intelligence that enables fully autonomous exploration of complex networks of corridors. A 4G LTE hotspot allows for cloud sharing of the resulting maps, video, and reports, while a wireless router allows for local sharing.

Efficiency of Flight.

Complex subterranean environments present extreme challenges to locomotion of wheeled, tracked and crawling robots, preventing the progress of some and reducing the potential rate of travel of others substantially, leading to very low productivity in terms of distance traveled and area covered. Conversely, a flying vehicle that can successfully operate within the subterranean environment will be able to move much faster, to overcome a vast array of impediments, and achieve a high level of productivity in exploration, mapping and reconnaissance. Thus a key innovation is the adaptation of autonomous drone operations to complex subterranean environments. Drones are now routinely employed in mapping, survey and ISR activities, with select examples even having successfully hosted hand-held lidar mapping equipment to image a cave structure. However, the typical size of such a drone is large compared to many of the underground spaces that need to be explored. Small form factor vehicles are needed to operate in tight spaces. But small battery-powered vehicles with large sensor payments suffer reduced flight time and short range, a challenge that must be overcome.

Self Organizing, Self Deployment and a Shared Map.

The finite range and endurance of a small battery-powered drone with sensor payload is a limiting factor for the overall reach of the autonomous mapping system. Innovative use of multiple drones, autonomously collaborating, can dramatically extend the range of operations over that feasible with a single battery-powered drone. In essence, we specify a base unit (containing multiple drones) placed near the opening to the subterranean space from which an initial mapping drone is launched. This drone enters the space and begins mapping/navigating at slow speed. The map is published and shared via network communications. As soon as a branch is encountered, this lead drone nominates a task for another drone to map the branch not taken by it, and the other available drones (still in the container at this point) bid on the job to self-select a candidate that then launches and employs the map that has been shared by the initial drone as a start. In this way multiple drones will be employed to much more quickly map the space.

Multiple Vehicles, Multiple Form Factors.

Multiple drones of varied size and capability are employed to suit the space being explored, autonomously deploying a larger drone with greater endurance when the map generated to that point so indicates, and then handing off to a smaller drone that can access much smaller spaces when necessary. Ultimately the base of operations can potentially be moved forward, autonomously, using drone variants specially designed to deliver additional batteries to the mapping drones.

Non Line of Sight Network Communications.

Communication between the drones is essential to their collaboration, and communication between the drones and the operator will enable ingestion of the maps as they are being generated, review of the collected imagery, and the ability to construct a common operating picture for the space, all in real-time. However, a common characteristic of the operating environment is the inability to maintain line-of-sight between the system elements, severely restricting the ability to communicate by line-of-sight radio transmissions. To overcome this limitation the mapping drones will also carry and intelligently deploy miniature battery-powered network nodes that will enable reliable communication throughout the explored space. Reliable network communication will enable another key innovation, that of shared and distributed map generation. Further the communications network can be exploited (while its battery power lasts) by human operators entering the space once the drone mapping and reconnaissance is complete.

Sensors Tailored to the Application.

The COTS scanning lidar solutions available are not ideally suited to SLAM in highly-confined spaces with uniform walls wherein experience has shown that lidar range a long distance down the tunnel may be needed to obtain robust SLAM results. Optimized sensor configurations are needed, as well as sensor diversity, while also ensuring low cost. Another key innovation is the exploitation of machine vision for mapping and obstacle avoidance, to compliment or even supplant lidar, in order to improve overall mapping performance, as well as reduce weight and cost, and to use thermal imaging including SWIR to see thru levels of dust and smoke. Another key innovation is to enable fast flight operations to peak productivity in exploration and mapping is to fully capture and then transmit (360 degree) high resolution video so that it can be reviewed and/or analyzed in virtual tours of the space independent of it collection.

Collaborative Teaming to Achieve Vast Coverage and Long Range in Short Time.

As explained above multiple drones will autonomously collaborate to dramatically accelerate the area that can be covered in a set amount of time. Further, once a mapping drone has reached its range limits, a second drone can, with the benefit of the previously generated map, fly very fast to reach the first drone's location, and then have significant battery remaining to penetrate further into the space. This leap-frog approach which exploits shared map information to fly very fast within the mapped space can be used repeatedly to extend range, and ultimately to enable resupply drones or rovers to deliver fresh batteries to the mapping drones deep within the space.

Navigation and 3D mapping is performed using a Real-Time Inertially-Aided Simultaneous Localization and Mapping (SLAM) algorithm that consumes the following sensor data: (1) LIDAR; (2) an inertial measurement unit; (3) when appropriate, a three-axis magnetometer from which magnetic heading can be derived; and (4) when GPS is available, a GPS receiver. The baseline design employs the Velodyne Puck LITE dual-return LIDAR which is environmentally sealed, and employs a wavelength of 903 nm. Range is up to 100 meters with +/−3 cm accuracy. Low-cost solid state LIDAR solutions are rapidly evolving for the automotive industry and will be exploited in the design as soon as practical. Machine vision to compliment, or as an alternative to, LIDAR will also be exploited in the design. The other sensors—3-axis angular rate (300 deg/sec), 3-axis accelerometer (6g), 3-axis magnetometer, and GPS receiver are shared with the autopilot. When available, GPS is used to initialize the map coordinate system to a set of absolute WGS84 position coordinates prior to entering the underground structure. All of the raw data is stored onboard to high-capacity SD cards and can be retrieved post flight. The SLAM solution is computed onboard the drone in real-time and the resultant 3D map of the processed point cloud data and associated drone trajectory is transmitted along with the imagery for display at the operator station in near real time.

The system employs a 360 by 240 degree Field of View 4K video camera (with associated high-intensity LED lighting array) as the primary imaging sensor. The camera employs 2880 by 2880 pixels, records at up to 50 mbps to 64 GB of internal storage space, and is IP67 rated. The image is corrected for lens distortion and is presented so that the user is able to remotely pan and zoom within the full FOV of the camera. Because a comprehensive view is captured in a single pass through the tunnel, it is possible for the drone to move very quickly through the space. And even though it is not possible in that single high-speed pass for the operator to fully observe all of the interior space, the operator (and associated image analysis tools) can fully inspect the tunnel post flight. It is thus possible to deliver the desired inspection capability in a small form factor drone that can fit through small openings using current battery technology. The 360 degree 4K camera can be used to identify a feature or target of interest with 20 pixels on a 0.1 meter object (˜4 inches square) at 3 meters range, 20 pixels on a 0.2 meter object at 6 meters, and 20 pixels on a 0.5 meter object at 16 meters. This visible spectrum camera is to be augmented with a SWIR camera. It enables imaging through significant levels of dust and other particulates.

Secure, high-bandwidth communications between the drone and the operator station can be achieved using miniature, disposable ad hoc radio network nodes intelligently released from the aircraft as it progresses through the space. Wireless, non-line-of-sight communications are thus maintained regardless of elevation and azimuth changes. With current battery sizing, the nodes remain active in the tunnel for up to 30+ minutes following their deployment, and are available to also enable non-line-of-sight communications for personnel that may enter the confined space following the drone operation. The nodes are designed to be disposable, and released from a rack on the aircraft using a simple servo and screw mechanism as illustrated below. Alternately the nodes can be retrieved by the drone using a mechanism so designed.

Seventeen or more self-righting network nodes can be deployed from the drone using an intelligent placement strategy as the mission evolves using the map that is being constructed. That is, the estimated location of the last deployed node within the generated map can be used for the continuous geometric calculation of line-of-sight between that node's location and the present location of the sUAS. As the sUAS maneuvers to progress forward through the confined space, the point at which line-of-sight with the last-deployed node will be blocked can be mathematically estimated, and the next node then intelligently deployed to insure line-of-sight between nodes is maintained. Alternately, when communication is determined to be compromised by degradation or loss of communications, the algorithm can command the drone to retrace its previous path (i.e. back up using the generated map and associated navigation within that map) until communication with the previous node is restored and then place a new node. The sUAS will then be able proceed forward again without loss of communication. This process can be repeated as many times as there are unused network nodes stored on the aircraft.

A customized hardware solution is required to meet constraints on node size, weight, and environmental compatibility. The custom unit is capable of 720p video transmission at 30 frames per second with less than 1 ms of lag (uncompressed). Simple omni-directional antenna (a dipole is shown in the image) will be employed to accommodate vertical shafts in the path or when the nodes do not deploy in an upright position.

Each node (low power setting) will consume about 0.9 W. Target weight for each node is 15 grams, with 3.5 grams allocated to battery weight. A 140 mAh LiPo cell would run the breadcrumb for 35 minutes. Each node's battery is held disconnected in the rack system with a normally open micro switch, and powered on when the breadcrumb is dropped by the mechanism. Another planned innovation: These breadcrumbs will employ retro-reflectors so as to be very easily identified in the vision and LiDAR imagery. The nodes will independently measure the distance between themselves using radio transmission time of flight. The known distances between each node's retro-reflectors visible within a given image, including LiDAR imagery, can then be used to mathematically to improve the accuracy and significantly reduce the drift of the SLAM-based mapping and navigation solution. Further, this independent measure of distance between nodes can be used to improve the estimated position of each node within the map and relative to the aircraft position, so as to improve, for example, the line-of-sight between nodes geometric calculation previously described.

Furthermore, direct force control (DFX) hex rotors can be employed to allow the aircraft to fly faster and maneuver more aggressively to avoid obstacles without causing mapping quality to degrade as it would with extreme attitude excursions for a non DFX sUAS maneuvering at such high speed. (For multirotors with six or more rotors, mounting the rotors at a fixed tilt angle allows independent direct force control in all directions. Thus horizontal translational motion can be achieved without having to change body attitude and vice versa.)

Another enhancement is landing gear and 360 degree guards that allow the aircraft to land anywhere for the purpose of serving as a radio network node, or to enable a companion sUAS time to catch up, or to enable autonomous swap of a battery, and then be able to take-off again despite having landed on uneven terrain.

The aircraft can have 4-6 cameras to allow stereo in horizontal flight as well as straight up and down, providing the opportunity to eliminate dependence of navigation and mapping on the LiDAR sensor, at least on those drones whose primary task on the collaborative team is not mapping but resupply. Having this relatively large number of cameras and having them in stereo pairs can significantly improve vision-based map precision and accuracy.

Another enhancement is the ability for the individual aircraft to perform some mapping locally (onboard) and to use it for obstacle avoidance. Then the local map is sent to nearby aircraft and to a central location to be combined. In addition some raw images can be sent that are chosen based on being helpful for local mapping.

The map is not assumed to be static and can be revised by new information

Any letter designations such as (a) or (b) etc. used to label steps of any of the method claims herein are step headers applied for reading convenience and are not to be used in interpreting an order or process sequence of claimed method steps. Any method claims that recite a particular order or process sequence will do so using the words of their text, not the letter designations.

Unless stated otherwise, terms such as “first” and “second” are used to arbitrarily distinguish between the elements such terms describe. Thus, these terms are not necessarily intended to indicate temporal or other prioritization of such elements.

Any trademarks listed herein are the property of their respective owners, and reference herein to such trademarks is generally intended to indicate the source of a particular product or service.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure.

1. A system for remotely mapping interior spaces comprising:
at least one small unmanned aircraft system (sUAS) comprising:
an omnidirectional imaging sensor;
an LED lighting array; and
a NLOS communications payload comprising:
a spool of fiberoptic tether; and
a fiber optic to Ethernet convertor; and
a ground control station (GCS) configured to send and receive signals from said sUAS through said fiber optic tether

2. The system of claim 1 wherein said ground control station further comprises a wearable display device configured to:
track the head movements of a user; and
display live omnidirectional video collected by the sUAS in an immersive virtual or augmented reality environment.

3. The system of claim 2 wherein said sUAS further comprises a flight controller configured for autonomous collision avoidance.

4. The system of claim 3 wherein said flight controller is operably coupled to one or more sensors, chosen from the group consisting of a camera, infrared range sensor, LiDAR, radar, or ultrasonic range sensor, for autonomous collision avoidance.

5. The system of claim 4 further comprising simultaneous localization and mapping algorithms run on a computer processor mounted onboard the sUAS to construct a 3D map of the interior space using data collected from said sensors in near-real time.

6. The system of claim 5 wherein said system is configured to transmit updates to the 3D map on the GCS in near real-time.

7. The system of claim 6 wherein said map is employed by said sUAS flight controller to autonomously localize and navigate within the interior space.

8. A system for remotely mapping interior spaces comprising;
At least one small unmanned aircraft system (sUAS) comprising:
an omnidirectional imaging sensor and;
an LED lighting array; and
a NLOS communications payload comprising;
one or more detachable network nodes; and
a ground control station (GCS) configured to communicate with said sUAS NLOS through a self-deployed network of said network nodes.

9. The system of claim 8 wherein said ground control station further comprises:
a wearable display device configured to:
track the head movements of a user and;
display live omnidirectional video collected by the sUAS in an immersive virtual or augmented reality environment.

10. The system of claim 9 wherein said sUAS further comprises flight controller configured for autonomous collision avoidance.

11. The system of claim 10 wherein said flight controller is operably coupled to one or more sensors, chosen from the group consisting of a camera, infrared range sensor, LiDAR, radar, or ultrasonic range sensor, for autonomous collision avoidance.

12. The system of claim 11 further comprising simultaneous localization and mapping algorithms run on a computer processor mounted onboard the sUAS to construct a 3D map of the interior space using data collected from said sensors in near-real time.

13. The system of claim 12 wherein said map is employed by said sUAS flight controller to autonomously localize and navigate within the interior space.

14. The system of claim 13 wherein updates to the 3D map generated by said SLAM algorithms are transmitted to the GCS in near real-time using a self-deployed network of said detachable radio nodes.

15. A system for remotely mapping interior spaces comprising at least one small unmanned aircraft system (sUAS) comprising:
a NLOS communications payload comprising; one or more detachable network nodes; and
a ground control station (GCS) configured to communicate with said sUAS NLOS through a self-deployed network of said detachable network nodes.

16. The system of claim 15 wherein said sUAS further comprises:
a flight controller configured for autonomous collision avoidance; and
wherein said flight controller is operably coupled to one or more sensors, chosen from the group consisting of a camera, infrared range sensor, LiDAR, radar, or ultrasonic range sensor, for autonomous collision avoidance.

17. The system of claim 16 further comprising simultaneous localization and mapping algorithms run on a computer processor mounted onboard the sUAS to construct a 3D map of the interior space using data collected from said sensors in near-real time.

18. The system of claim 17 wherein said map is employed by said sUAS flight controller to autonomously localize and navigate within the interior space.

19. The system of claim 18 wherein updates to the 3D map generated by said SLAM algorithms are transmitted to the GCS in near real-time using said self-deployed network detachable radio nodes.
